(19) United States
(12) Patent Application Publication
(10) Pub. No.: US 2025/0336277 A1
(43) Pub. Date: Oct. 30, 2025

(54) INTEGRATING A FIRE ALARM SYSTEM WITH SMART ELECTRICAL SOCKETS OF A FACILITY

(71) Applicant: Honeywell International Inc., Charlotte, NC (US)

(72) Inventors: Kanhayia Kumar, Bangalore (IN); Nilesh Chaudhari, Bangalore (IN); Rajiv R. Singh, Bangalore (IN); Siddhartha Chatterjee, Cumming, GA (US); Venugopal Kilingar Nadumane, Bangalore (IN)

(21) Appl. No.: 19/188,765

(22) Filed: Apr. 24, 2025

(30) Foreign Application Priority Data
Apr. 24, 2024 (IN) 202411032459

(51) Int. Cl. G08B 17/06; G08B 3/10; G08B 17/10; G08B 25/14; H01R 13/713

(52) U.S. Cl. CPC G08B 17/06; G08B 3/10; G08B 17/10; G08B 25/14; H01R 13/713

(57) ABSTRACT

A building management system and method for responding to possible fire events in a facility. The system includes a smart electrical socket with a plug receptacle that can switch power on/off, a fire alarm controller, fire detector, and sounding device. The system detects possible fires through smoke/heat detection or by monitoring socket temperature and power delivery thresholds. Upon fire detection, the system activates a sounding device and/or sends alerts to an operator console while instructing the smart socket to cut power. In some cases, the socket contains sensors to detect predetermined operating conditions and can notify the fire controller. Communication may occur through gateway devices forming separate networks-one for fire system components and another for smart sockets. These networks can communicate directly or via cloud servers. The system can selectively power on different sockets in response to fire events, such as for emergency lighting.

### RELATED APPLICATIONS

This application claims the benefit of Indian Provisional Application No. 202411032459 filed Apr. 24, 2024, which application is incorporated by reference herein.

### TECHNICAL FIELD

The present disclosure relates generally to building management systems, and more particularly to building management systems integrating a fire alarm system with smart electrical sockets of a facility.

### BACKGROUND

Building management systems, particularly in large facilities, can be complex and often include a large number of building components. Building management systems may include fire alarm systems. Building management systems may include connected power systems in which smart electrical sockets powering one or more appliances may be monitored and remotely controlled. M any fires are caused or exacerbated by electrical shorts. What would be desirable are building management systems that are able to detect possible fires in the facility and quickly shut off power to appliances via the smart electrical socket to reduce fire risks.

### SUMMARY

The present disclosure relates generally to building management systems, and more particularly to building management systems integrating a fire alarm system with smart electrical sockets of a facility. An example may be found in a method for responding to a possible fire event in a facility. The illustrative method includes detecting the possible fire event in the facility. In response to detecting the possible fire event in the facility, an alert is sent to an operator console of the facility and/or a sounding device in the facility is activated. A smart electrical socket in the facility is instructed to switch power off to a plug receptacle of the smart electrical socket. An electrical appliance may be plugged into the plug receptacle of the smart electrical socket.

Another example may be found in a building management system. The illustrative building management system includes a smart electrical socket with a plug receptacle for selectively receiving a plug from an electrical appliance. The smart electrical socket is configured to controllably switch power on and off to the plug receptacle of the smart electrical socket, and thus to the corresponding electrical appliance. The illustrative building management system includes a fire alarm controller, a fire detector, and a sounding device. The fire alarm controller is configured to receive a notification from the fire detector when the fire detector detects a possible fire, and in response, the fire alarm controller is configured to activate the sounding device and to instruct the smart electrical socket to switch power off to the plug receptacle of the smart electrical socket, and thus to the corresponding electrical appliance.

Another example may be found in a building management system. The illustrative building management system includes a smart electrical socket having a plug receptacle for selectively receiving a plug from an electrical appliance. The smart electrical socket is configured to controllably switch power on and off to the plug receptacle of the smart electrical socket. The smart electrical socket includes one or more sensors for sensing one or more sensed conditions associated with the smart electrical socket. The building management system includes a fire alarm controller, a fire detector, and a sounding device. The smart electrical socket is configured to detect a predetermined operating condition of the smart electrical socket based at least in part on one or more of the sensed conditions, and when the predetermined operating condition is detected, the smart electrical socket is configured to notify the fire alarm controller of the detected predetermined operating condition. The fire alarm controller, in response to being notified of the predetermined operating condition of the smart electrical socket, sends an alert to an operator console of the building management system and/or activates the sounding device. The predetermined operating condition may include, for example, a sensed temperature that is above a temperature threshold and/or a current draw by the electrical appliance that is above current threshold. These are just examples.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative building management system;

FIG. 2 is a flow diagram showing an illustrative method for responding to a possible fire event in a facility; and

FIG. 3 is a schematic block diagram showing illustrative interplay between a fire alarm system and a connected power system in several use cases.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

The present disclosure relates generally to methods and systems for responding to possible fire events in a facility. In an illustrative method includes detecting a possible fire event in a facility. In some cases, detecting the possible fire event in the facility includes detecting smoke and/or heat in the facility by one or more fire detectors of a fire alarm system. In some cases, detecting the possible fire event in the facility may include detecting a temperature inside of a smart electrical socket of the facility has exceeded a temperature threshold. In some cases, detecting the possible fire event in the facility includes detecting a power level delivery (e.g. current draw) to a plug receptacle of a smart electrical socket of the facility has exceeded a power level threshold. Regardless of how the possible fire event is detected, the illustrative method includes sending an alert to an operator console of the facility and/or activating a sounding device in the facility, as well as instructing one or more of the smart electrical sockets in the facility to switch power off to a plug receptacle of one or more of the smart electrical socket(s). In some cases, in response to detecting the possible fire event in the facility, the method may include instructing one or more smart electrical socket in the facility to switch power on (e.g. smart electrical sockets providing power to emergency lighting). In some cases, the method includes, in response to detecting the possible fire event in the facility, also activating the sounding device in the facility.

In some cases, in response to detecting a possible fire event in the facility by detecting that a temperature inside of a smart electrical socket of the facility has exceeded the temperature threshold, the method may include sending an alert to the operator console of the facility but letting the operator decide whether to active the sounding device of the facility. Likewise, in response to detecting a possible fire event in the facility by detecting a power level delivery to a plug receptacle of a smart electrical socket of the facility has exceeded a power level threshold, the method may include sending an alert to the operator console of the facility but letting the operator decide whether to activate the sounding device of the facility. In some cases, the sounding device of the facility may be automatically activated upon detecting a possible fire event.

In some cases, the power level threshold may be a maximum power level rating for the smart electrical socket. In some cases, the power level threshold may be a maximum power level rating for the appliance plugged into the smart electrical socket. In some cases, the power level threshold may be based at least in part on a historical power level delivered to the plug receptacle of the particular smart electrical socket. When so provided, the power level threshold may be set in reference to a past “normal” power level that is drawn by the appliance that is plugged into the smart electrical socket, and when the power level delivery to the plug receptacle of the smart electrical socket exceeds the historical “normal” power level of the appliance by at least a threshold amount (and sometimes for at least a threshold period of time), a possible fire event may be detected.

In some cases, a building management system may include a smart electrical socket that includes a plug receptacle for selectively receiving a plug from an electrical appliance and that is configured to controllably switch power on and off to the plug receptacle of the smart electrical socket. The building management system may include a fire alarm controller, a fire detector, and a sounding device. The fire alarm controller may be configured to receive a notification from the fire detector when the fire detector detects a possible fire event, and in response, the fire alarm controller is configured to activate the sounding device and to instruct the smart electrical socket to switch power off to the plug receptacle of the smart electrical socket. In some cases, in response to receiving the notification from the fire detector when the fire detector detects the possible fire event, the fire alarm controller may be configured to instruct one or more different smart electrical socket to switch power on to a plug receptacle of the one or more different smart electrical socket (e.g. one or more smart electrical sockets providing power to emergency lighting).

The building management system may further include a first gateway device that is operatively coupled to the fire alarm controller, the fire detector and the sounding device, and forms a first network with the fire alarm controller, the fire detector and the sounding device. The building management system may further include a second gateway device that is operatively coupled to the smart electrical socket, and forms a second network with one or more smart electrical sockets including the smart electrical socket. The fire alarm controller may be configured to receive the notification from the fire detector when the fire detector detects a possible fire event over the first network, and in response, activate the sounding device over the first network and instruct the smart electrical socket to switch power off to the plug receptacle of the smart electrical socket via a communication path that includes the first gateway device and the second gateway device and the second network. In some cases, the communication path may extend directly between the first gateway device and the second gateway device. In some cases, the communication path may extend indirectly between the first gateway device and the second gateway device, sometimes via one or more intervening cloud servers.

In some cases, the smart electrical socket may include one or more sensors for sensing one or more sensed conditions associated with the smart electrical socket. The smart electrical socket may be configured to detect a predetermined operating condition of the smart electrical socket based at least in part on one or more of the sensed conditions, and when the predetermined operating condition is detected, the smart electrical socket may be configured to notify the fire alarm controller of the detected predetermined operating condition. The fire alarm controller, in response to being notified of the predetermined operating condition of the smart electrical socket, may send an alert to an operator console of the building management system and/or activates the sounding device. The predetermined operating condition may include, for example, a sensed temperature that is above a temperature threshold (e.g. via a temperature sensor of the smart electrical socket), a current draw of the electrical appliance that is plugged into the smart electrical socket that is above a current threshold (e.g. via a current sensor of the smart electrical socket) and/or a smoke detected by a smoke sensor of the smart electrical socket (e.g. via a smoke sensor of the smart electrical socket). These are just examples.

A building management system may include a smart electrical socket that includes a plug receptacle for selectively receiving a plug from an electrical appliance and that is configured to controllably switch power on and off to the plug receptacle of the smart electrical socket, and wherein the smart electrical socket includes one or more sensors for sensing one or more sensed conditions associated with the smart electrical socket. The building management system also includes a fire alarm controller, a fire detector, and a sounding device. The smart electrical socket may be configured to detect a predetermined operating condition of the smart electrical socket based at least in part on one or more of the sensed conditions, and when the predetermined operating condition is detected, the smart electrical socket may be configured to notify the fire alarm controller of the detected predetermined operating condition. The fire alarm controller, in response to being notified of the predetermined operating condition of the smart electrical socket, may send an alert to an operator console of the building management system and/or may activate the sounding device. In some cases, when the predetermined operating condition is detected by the smart electrical socket, the smart electrical socket may be configured to switch power off to the plug receptacle of the smart electrical socket.

In some cases, the building management system may include a first gateway device that is operatively coupled to the fire alarm controller, the fire detector and the sounding device and forms a first network with the fire alarm controller, the fire detector and the sounding device. The building management system may further include a second gateway device that is operatively coupled to the smart electrical socket and forms a second network with the smart electrical socket. The fire alarm controller may be configured to communicate with the smart electrical socket via a communication path that includes the first gateway device and the second gateway device. In some cases, the communication path may extend directly between the first gateway device and the second gateway device. In some cases, the communication path may extend indirectly between the first gateway device and the second gateway device, sometimes via one or more intervening cloud servers. In some cases, the fire alarm controller may be configured to receive a notification from the fire detector when the fire detector detects a possible fire, and in response, the fire alarm controller may be configured to activate the sounding device and instruct the smart electrical socket to switch power off to the plug receptacle of the smart electrical socket. In some cases, the fire alarm controller may receive a notification of a possible fire event detected by the smart electrical socket via the communication path.

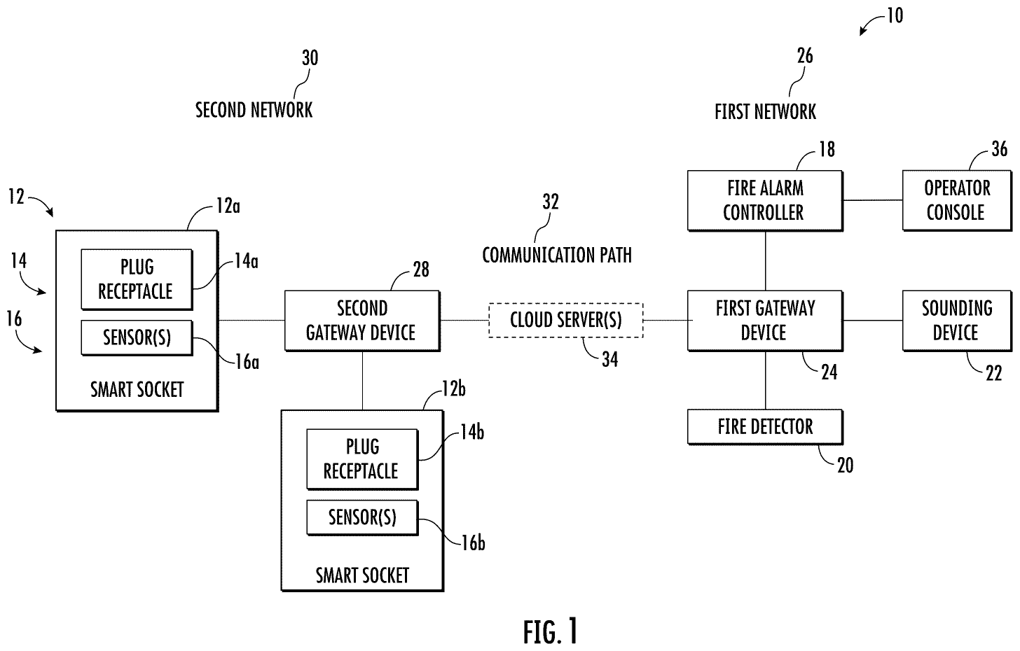

FIG. 1 is a schematic block diagram showing an illustrative building management system 10. The illustrative building management system 10 may be deployed within any of a variety of different types and sizes of facilities. The building management system 10 includes one or more smart electrical sockets 12, individually labeled as 12a and 12b. While two smart electrical sockets 12 are shown, the building management system 10 may include any number of smart electrical sockets 12, and in some cases may include substantially more than two smart electrical sockets 12. Each of the smart electrical sockets 12 include a plug receptacle 14, individually labeled as 14a and 14b, for selectively receiving a plug from an electrical appliance. While each of the smart electrical sockets 12 are shown as including a single plug receptacle 14, in some cases, at least some of the smart electrical sockets 12 may include two or even more plug receptacles 14. Each of the smart electrical sockets 12 are configured to controllable switch power on and off to the plug receptacle 14 of each smart electrical socket 12 via one or more commands received from the second gateway device 28. Each of the smart electrical sockets 12 include one or more sensors 16, individually labeled as 16a and 16b. The sensors 16 are configured to sense one or more sensed conditions that are associated with the particular smart electrical socket 12. As an example, the sensors 16 may be configured to measure temperatures within the smart electrical socket 12. As another example, the sensors 16 may be configured to measure a current or another indication of how much power is being provided to an electrical appliance via the plug receptacle 14 of a particular smart electrical socket 12. In another example, the sensors 16 may be configured to a detect smoke, a carbon monoxide, a CO2, light (visible, UV, etc.) and/or any other suitable sensor. These are just examples.

The building management system 10 includes a fire alarm controller 18, a fire detector 20, and a sounding device 22 such as a siren. The fire alarm controller 18 is configured to receive a notification from the fire detector 20 when the fire detector 20 detects a possible fire. In response, the fire alarm controller 18 is configured to activate the sounding device 22 and to instruct the smart electrical socket 12 to switch power off to the plug receptacle 14 of the smart electrical socket 12. In some cases, in response to receiving the notification from the fire detector 20 when the fire detector 20 detects the possible fire, the fire alarm controller 18 may be configured to instruct a different smart electrical socket 12 to switch power on to a plug receptacle 14 of the different smart electrical socket 12. As an example, the smart electrical socket 12a may be the first smart electrical socket 12, and the smart electrical socket 12b may be the second or different smart electrical socket 12. In some cases, when a fire is detected in a first zone of the facility, the fire alarm controller may be configured to instruct one or more smart electrical sockets 12 that are location in the first zone to switch power off, while not instructing one or more smart electrical sockets 12 in other zones of the facility to switch power off.

In some cases, a first gateway device 24 may be operatively coupled to the fire alarm controller 18, the fire detector 20, and the sounding device 22. In some cases, the first gateway device 24 forms a first network 26 with the fire alarm controller 18, the fire detector 20, and the sounding device 22. In some cases, a second gateway device 28 may be operatively coupled to the smart electrical sockets 12 and may form a second network 30 with the smart electrical sockets 12. As an example, the fire alarm controller 18 may be configured to receive the notification from the fire detector 20 over the first network 26 and to activate the sounding device 22 over the first network 26. The fire alarm controller 18 may be configured to instruct the smart electrical socket 12 to switch power off to the plug receptacle 14 of the smart electrical socket 12 via a communication path 32 that includes the first gateway device 24 and the second gateway device 28 and the second network 30. In some cases, the communication path 32 extends directly between the first gateway device 24 and the second gateway device 28. In some cases, the communication path 32 extends indirectly between the first gateway device 24 and the second gateway device 28 because there are one or more cloud servers 34 disposed between the first gateway device 24 and the second gateway device 28.

In some cases, the smart electrical socket 12 may be configured to detect a predetermined operating condition of the smart electrical socket 12 based at least in part on one or more of the sensed conditions, and when the predetermined operating condition is detected, the smart electrical socket 12 may be configured to notify the fire alarm controller 18 of the detected predetermined operating condition. The fire alarm controller 18, in response to being notified of the predetermined operating condition of the smart electrical socket 12, sends an alert to an operator console 36 of the building management system 10 and/or activates the sounding device 22.

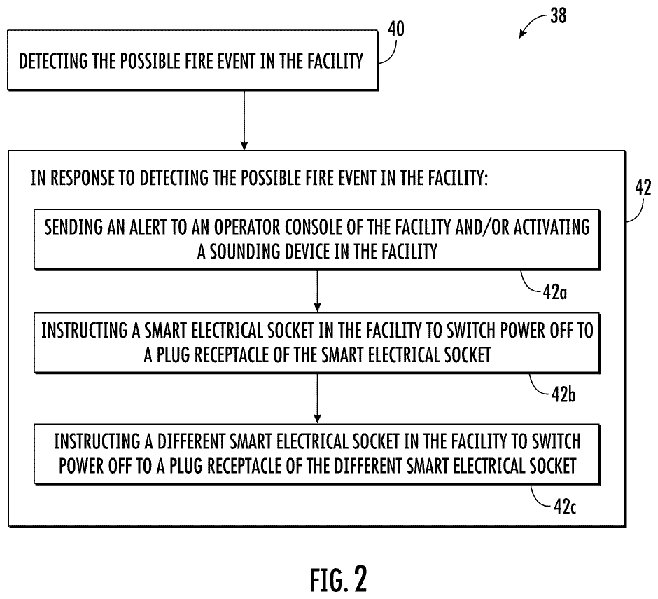

FIG. 2 is a flow diagram showing an illustrative method 38 for responding to a possible fire event in a facility. The method 38 includes detecting the possible fire event in the facility, as indicated at block 40. Several steps are taken in response to detecting the possible fire event in the facility, as indicated at block 42. Detecting a possible fire event may include detecting smoke and/or heat in the facility by one or more of fire detectors. Detecting a possible fire event may include detecting that a temperature inside of the smart electrical socket has exceeded a temperature threshold. Detecting a possible fire event may include detecting that a power delivery to the plug receptacle of the smart electrical socket has exceeded a power threshold. The power threshold may be based at least in part on a historical power level delivered to the plug receptacle of the smart electrical socket. The steps include sending an alert to an operator console of the facility and/or activating a sounding device in the facility, as indicated at block 42a. In some cases, the sounding device is activated. When the temperature inside of the smart electrical socket has exceeded the temperature threshold, an alert may be sent to the operator console. The steps include instructing a smart electrical socket in the facility to switch power off to a plug receptacle of the smart electrical socket, as indicated at block 42b. In some cases, in response to detecting the possible fire event in the facility, instructing a different smart electrical socket in the facility may be instructed to switch power on to a plug receptacle of the different smart electrical socket, as indicated at block 42c.

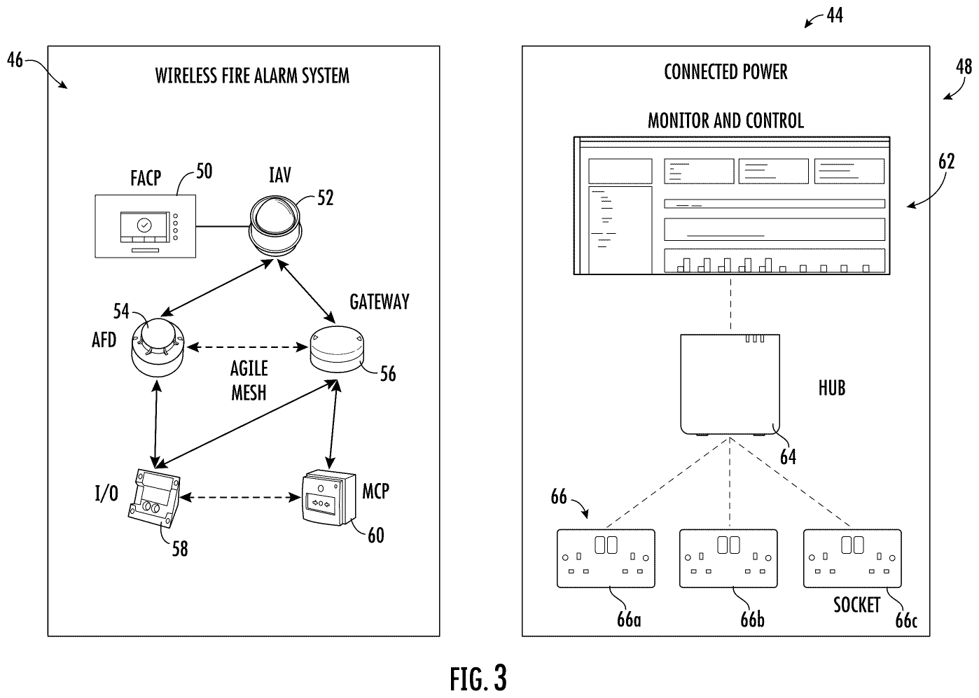

FIG. 3 is a schematic block diagram showing an illustrative building management system 44 that includes a wireless fire alarm system 46 and a connected power system 48. The wireless fire alarm system 46 includes a Fire Alarm Control Panel (FACP) 50, a sounding device 52, a fire detector 54, a gateway 56, an IO board 58 and an MCP 60. The connected power system 48 includes a dashboard 62, a hub 64, and several smart electrical sockets 66, individually labeled as 66a, 66b, and 66c.

In a first use case, the fire detector 54 detects a fire alarm. This causes the FACP 50 to go into alarm and the sounding device 52 to sound an alarm. The gateway 56 sends a command to the hub 64 (either directly or indirectly). The hub 64 receives the command, and in response, commences a plug deactivation strategy by sending a command to each of the smart electrical sockets 66 that are in the same room as the detected fire alarm. In response, the appliances plugged into the smart electrical sockets 66 in the same room are shut off.

In a second use case, one of the smart electrical sockets 66 overheats. The overheating smart electrical socket 66 informs the hub 64, which in response commences a plug deactivation strategy by instructing the overheating smart electrical socket 66 to shut off power to the connected appliance. The hub 64 also sends the event to the gateway 56. The gateway 56 forwards the event to the FACP 50. In this example use case, the FACP 50 indicates the event to be a technical alarm, and a technical alarm output is activated by the IO board 58.

In a third use case, one of the smart electrical sockets 66 outputs more power for a longer duration than expected. The hub 64 receives the event from the smart electrical socket 66, which commences a plug deactivation strategy by sending a shut off command to the particular smart electrical socket 66. The hub 64 sends the event to the gateway 56. The gateway 56 forwards the event to the FACP 50. In this example use case, the FACP 50 indicates the event to be a technical alarm, and a technical alarm output is activated by the IO board 58.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for responding to a possible fire event in a facility, comprising:
detecting the possible fire event in the facility;
in response to detecting the possible fire event in the facility:
sending an alert to an operator console of the facility and/or activating a sounding device in the facility; and
instructing a smart electrical socket in the facility to switch power off to a plug receptacle of the smart electrical socket.

2. The method of claim 1, wherein detecting the possible fire event in the facility comprises detecting smoke and/or heat in the facility by one or more fire detectors.

3. The method of claim 2, wherein in response to detecting the possible fire event in the facility, activating the sounding device in the facility.

4. The method of claim 1, wherein detecting the possible fire event in the facility comprises detecting that a temperature inside of the smart electrical socket has exceeded a temperature threshold.

5. The method of claim 4, wherein, in response to detecting the possible fire event in the facility by detecting that the temperature inside of the smart electrical socket has exceeded the temperature threshold, sending the alert to the operator console of the facility.

6. The method of claim 1, wherein detecting the possible fire event in the facility comprises detecting that a power delivery to the plug receptacle of the smart electrical socket has exceeded a power threshold.

7. The method of claim 6, wherein the power threshold is based at least in part on a historical power level delivered to the plug receptacle of the smart electrical socket.

8. The method of claim 1, wherein in response to detecting the possible fire event in the facility, instructing a different smart electrical socket in the facility to switch power on to a plug receptacle of the different smart electrical socket.

9. A building management system comprising:
a smart electrical socket that includes a plug receptacle for selectively receiving a plug from an electrical appliance, the smart electrical socket is configured to controllably switch power on and off to the plug receptacle of the smart electrical socket;
a fire alarm controller;
a fire detector;
a sounding device;
the fire alarm controller is configured to receive a notification from the fire detector when the fire detector detects a possible fire, and in response, the fire alarm controller is configured to:
activate the sounding device; and
instruct the smart electrical socket to switch power off to the plug receptacle of the smart electrical socket.

10. The building management system of claim 9, wherein in response to receiving the notification from the fire detector when the fire detector detects the possible fire, the fire alarm controller is configured to instruct a different smart electrical socket to switch power on to a plug receptacle of the different smart electrical socket.

11. The building management system of claim 9, comprising:
a first gateway device that is operatively coupled to the fire alarm controller, the fire detector and the sounding device and forms a first network with the fire alarm controller, the fire detector and the sounding device;
a second gateway device that is operatively coupled to the smart electrical socket and forms a second network with the smart electrical socket;
wherein the fire alarm controller is configured to receive the notification from the fire detector over the first network and is configured to activate the sounding device over the first network; and
wherein the fire alarm controller is configured to instruct the smart electrical socket to switch power off to the plug receptacle of the smart electrical socket via a communication path that includes the first gateway device and the second gateway device and the second network.

12. The building management system of claim 11, wherein the communication path extends directly between the first gateway device and the second gateway device.

13. The building management system of claim 11, wherein the communication path extends indirectly between the first gateway device and the second gateway device via one or more cloud servers.

14. The building management system of claim 9, wherein:
the smart electrical socket includes one or more sensors for sensing one or more sensed conditions associated with the smart electrical socket;
the smart electrical socket is configured to detect a predetermined operating condition of the smart electrical socket based at least in part on one or more of the sensed conditions, and when the predetermined operating condition is detected, the smart electrical socket is configured to notify the fire alarm controller of the detected predetermined operating condition; and
the fire alarm controller, in response to being notified of the predetermined operating condition of the smart electrical socket, sends an alert to an operator console of the building management system and/or activates the sounding device.

15. A building management system comprising:
a smart electrical socket that includes a plug receptacle for selectively receiving a plug from an electrical appliance, the smart electrical socket is configured to controllably switch power on and off to the plug receptacle of the smart electrical socket, and the smart electrical socket includes one or more sensors for sensing one or more sensed conditions associated with the smart electrical socket;
a fire alarm controller;
a fire detector;
a sounding device;
the smart electrical socket is configured to detect a predetermined operating condition of the smart electrical socket based at least in part on one or more of the sensed conditions, and when the predetermined operating condition is detected, the smart electrical socket is configured to notify the fire alarm controller of the detected predetermined operating condition; and
the fire alarm controller, in response to being notified of the predetermined operating condition of the smart electrical socket, sends an alert to an operator console of the building management system and/or activates the sounding device.

16. The building management system of claim 15, wherein when the predetermined operating condition is detected by the smart electrical socket, the smart electrical socket is configured to switch power off to the plug receptacle of the smart electrical socket.

17. The building management system of claim 15, comprising:
a first gateway device that is operatively coupled to the fire alarm controller, the fire detector and the sounding device and forms a first network with the fire alarm controller, the fire detector and the sounding device;
a second gateway device that is operatively coupled to the smart electrical socket and forms a second network with the smart electrical socket; and
wherein the fire alarm controller is configured to be notified by the smart electrical socket via a communication path that includes the first gateway device and the second gateway device.

18. The building management system of claim 17, wherein the communication path extends directly between the first gateway device and the second gateway device.

19. The building management system of claim 17, wherein the communication path extends indirectly between the first gateway device and the second gateway device via one or more cloud servers.

20. The building management system of claim 15, wherein:
the fire alarm controller is configured to receive a notification from the fire detector when the fire detector detects a possible fire, and in response, the fire alarm controller is configured to:
activate the sounding device; and
instruct the smart electrical socket to switch power off to the plug receptacle of the smart electrical socket.
